(19) United States
(12) Patent Application Publication
(10) Pub. No.: US 2022/0029328 A1
(43) Pub. Date: Jan. 27, 2022

(54) INSTALLATION STRUCTURE OF SUNKEN FPC CONNECTOR

(71) Applicant: Goldenconn Electronic Technology Co., Ltd, Suzhou (CN)

(72) Inventors: Jinsong Chen, Suzhou (CN); Guofang Xia, Suzhou (CN)

(21) Appl. No.: 17/425,553

(22) PCT Filed: Nov. 27, 2020
(86) PCT No.: PCT/CN2020/131996

§ 371 Date: Jul. 23, 2021

(30) Foreign Application Priority Data
Apr. 2, 2020 (CN) 202010254283.8

(51) Int. Cl. H01R 12/77; H01R 43/02; H01R 12/70

(52) U.S. Cl. CPC H01R 12/774; H01R 12/707; H01R 43/02

(57) ABSTRACT

A sunken FPC (Flexible Printed Circuit) connector includes an FPC connector and a circuit board, which are fixedly connected to each other, wherein the FPC connector comprises an insulating plastic base, an outer shell, wiring terminals and an FFC; the outer shell comprises a top plate, a bottom plate, and a connecting plate; an installation notch adapted to the shape of the FPC connector is provided on the circuit board; and a left bending fixed arm and a right bending fixed arm respectively extend upward from the left and right ends of the bottom plate. When being put in place relative to the installation notch, the FPC connector is welded and fixed with the circuit board by means of the left bending fixed arm and the right bending fixed arm, respectively.

### TECHNICAL FIELD

The present invention relates to the technical field of flexible flat cable FPC (Flexible Printed Circuit) connector manufacturing, in particular to an installation structure of a sunken FPC connector.

### BACKGROUND

A Flexible Flat Cable (FFC) is used as a signal transmission component, and itself has the advantages such as arbitrary winding and high signal transmission, so it is widely used in many electronic products. The flexible flat cable is used in collocation with an electronic connector through an FPC connector to transmit a signal from one end to the other, so as to achieve the purpose of signal transmission. The flexible flat cable is usually applied to various digital communication products, portable electronic products, computer peripheral devices, measuring instruments, automotive electronics and other fields.

At present, most of the FPC connector installation structures on the market adopt a top-mounted structure, that is, an FPC connector is directly welded and fixed on the upper surfaces of a circuit board (as shown in FIG. 1). In this way, the size of the FPC connector installation structure in the height direction is increased, thereby inevitably increasing the demand for installation space, which is not conducive to the miniaturization and integrated design of electronic products. In addition, generally speaking, most of the existing connectors use a flip-top or press-type structure to realize the installation and disassembly operations of flexible flat cable. Therefore, due to the influence of the size factor in the height direction, it is not conducive to realizing the installation and disassembly operations of flexible flat cables relative to FPC connectors. Therefore, it is urgently necessary for technical personnel to solve the above problems.

### SUMMARY

The technical problem to be solved by the present invention is to provide an installation structure of a sunken FPC (Flexible Printed Circuit) connector, which is simple in structural design, convenient for installation and disassembly of FFC (Flexible Flat Cable), and is conducive to realizing the overall miniaturization and integrated design target of electronic components.

In order to solve the above-mentioned technical problem, the present invention relates to a Flexible Printed Circuit (FPC) assembly, comprising: an FPC connector, comprising: an insulating plastic base, the insulating plastic base is provided with an insertion slots, and a plurality of insertion holes are provided in the insertion slots; a shell, comprising a top plate, a bottom plate and a connecting plate, the connecting plate is arranged between a rear end of the top plate and the bottom plate, and the shell having two opposite first sides and two opposite second sides, wherein the bottom plate comprises a first bending fixed arm and a second bending fixed arm, which respectively extend from the two first sides; wiring terminals, in plug-in connection with the insertion holes; and a flexible flat cable, in plug-in connection with the insertion slots; and a circuit board, provided with an installation port adapted to the outer contour of the FPC connector; wherein, when the circuit board is inserted into the FPC connector, and after the FPC connector is in abutting contact with the installation port, the circuit board is connected with the first bending fixed arm and the second bending fixed arm by welding, respectively, thereby realizing the connection and fixation between the FPC connector and the circuit board.

As a further improvement of the technical solution of the present invention, wherein the bottom plate further comprises a plurality of grounding elastic pieces arranged along a length direction of the bottom plate, and the grounding elastic pieces are welded and fixed with the flexible flat cable.

As a further improvement of the technical solution of the present invention, wherein the bottom plate further comprises at least two grounding soldering lugs extending outward from one second side away from the circuit board, and the grounding soldering lugs are connected to the circuit board by welding, wherein the extension direction of the first sides is the same as the insertion direction of the circuit board.

As a further improvement of the technical solution of the present invention, wherein the grounding soldering lugs further comprise elastic bending portions, which are formed by bending the tail ends of the grounding soldering lugs along the length direction of the bottom plate.

As a further improvement of the technical solution of the present invention, wherein the top plate further comprises a first clamping arm and a second clamping arm, which extend from one second side close to the circuit board toward the bottom plate, at least two clamping portions extend from the tail end of the first clamping arm and/or the second clamping arm toward the top plate, and the two clamping portions are adapted to at least two installation slots formed on the flexible flat cable.

As a further improvement of the technical solution of the present invention, wherein the top plate further comprises a plurality of flanges extending from one second side away from the circuit board and toward the bottom plate; when one second side of the top plate is pressed, the top plate rotates around the central axis of the flanges, such that the clamping portions move toward a direction away from the installation slots on the both sides of the flexible flat cable, thereby realizing the separation between the flexible flat cable and the insertion slots.

As a further improvement of the technical solution of the present invention, wherein inclined portions are arranged at one ends of the clamping portions close to the circuit board, and the inclination direction of the inclined portions is consistent with the insertion direction of the flexible flat cable.

As a further improvement of the technical solution of the present invention, wherein the bottom plate further comprises a plurality of fixed jaws extending outward from one second side close to the circuit board, and sliding slots adapted to the fixed jaws are formed on the insulating plastic base.

As a further improvement of the technical solution of the present invention, wherein the fixed jaws comprise protrusions extending from the two corresponding sides of the fixed jaws.

As a further improvement of the technical solution of the present invention, wherein the top plate further comprises hook portions extending from one second side close to the circuit board and toward the bottom plate, and recesses adapted to the hook portions are formed in the insulating plastic base.

Compared with the installation structure of the FPC connector in the traditional design structure, in the technical solution disclosed in the present invention, the installation port is formed on the circuit board for sinking the FPC connector, and the FPC connector is subsequently welded and fixed with the circuit board through the first bending fixed arm and the second bending fixed arm arranged on the left and right sides of the FPC connector. In this way, on one hand, the overall height value of the installation structure of the FPC connector is effectively reduced, which is conducive to the miniaturization and integrated design of its superior components; and on the other hand, an enough space is reserved for the implementation of installation and disassembly operations of the FFC.

### BRIEF DESCRIPTION OF THE DRAWINGS

To illustrate technical solutions in the embodiments of the present invention or in the prior art more clearly, a brief introduction on the accompanying drawings which are needed in the description of the embodiments or the prior art is given below. Apparently, the accompanying drawings in the description below are merely some of the embodiments of the present invention, based on which other accompanying drawings can be obtained by those of ordinary skill in the art without any creative effort.

FIG. 1 is a three-dimensional schematic diagram with regard to installation structures of FPC connectors in the prior art.

FIG. 2 is a three-dimensional schematic diagram with regard to the installation structure of the sunken FPC connector in the present invention.

FIG. 3 is a top view of FIG. 1.

FIG. 4 is an A-A section view of FIG. 3.

FIG. 5 is a three-dimensional schematic diagram with regard to the circuit board in the installation structure of the sunken FPC connector in the present invention.

FIG. 6 is a three-dimensional schematic diagram with regard to the FPC connector in the installation structure of the sunken FPC connector in the present invention.

FIG. 7 is an exploded view with regard to the FPC connector in the installation structure of the sunken FPC connector in the present invention.

FIG. 8 is a top view of FIG. 6.

FIG. 9 is a B-B section view of FIG. 8.

FIG. 10 is a C-C section view of FIG. 8.

FIG. 11 is a D-D section view of FIG. 8.

FIG. 12 is a three-dimensional schematic diagram with regard to one viewing angle of the insulating plastic base in the installation structure of the sunken FPC connector in the present invention.

FIG. 13 is a three-dimensional schematic diagram with regard to another viewing angle of the insulating plastic base in the installation structure of the sunken FPC connector in the present invention.

FIG. 14 is a three-dimensional schematic diagram with regard to one viewing angle of the shell in the installation structure of the sunken FPC connector in the present invention.

FIG. 15 is a partial enlarged view of I in FIG. 14.

FIG. 16 is a top view of FIG. 14.

FIG. 17 is an E-E section view of FIG. 16.

FIG. 18 is a three-dimensional schematic diagram with regard to another viewing angle of the shell in the installation structure of the sunken FPC connector in the present invention.

FIG. 19 is a three-dimensional schematic diagram with regard to the FFC in the installation structure of the sunken FPC connector in the present invention.

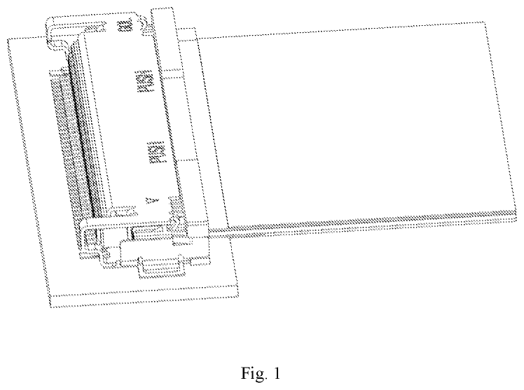

1—FPC connector; 11—insulating plastic base; 111—insertion slot; 112—insertion hole; 113—sliding slot; 114—hook groove; 12—shell; 121—top plate; 1211—first clamping arm; 12111—clamping portion; 121111—inclined portion; 1212—second clamping arm; 1213—flange; 1214—hook portion; 122—bottom plate; 1221—first bending fixed arm; 1222—second bending fixed arm; 1223—grounding elastic piece; 1224—grounding soldering lug; 12241—elastic bending portion; 1225—fixed jaw; 12251—protrusion; 123—connecting plate; 13—wiring terminal; 14—FFC; 141—installation slot; 2—circuit board; 21—installation port.

### DETAILED DESCRIPTION

In the description of the present invention, it should be understood that the orientation or positional relationships indicated by the terms “left”, “right”, “upper”, “lower”, “front”, “rear” and the like are orientation or positional relationships shown on the basis of the drawings, which are only for the convenience of describing the present invention and simplifying the description, rather than indicating or implying that the devices or elements referred to must have specific orientations or position relationships, or must be constructed and operated in specific orientations, and thus cannot be understood as limitations of the present invention.

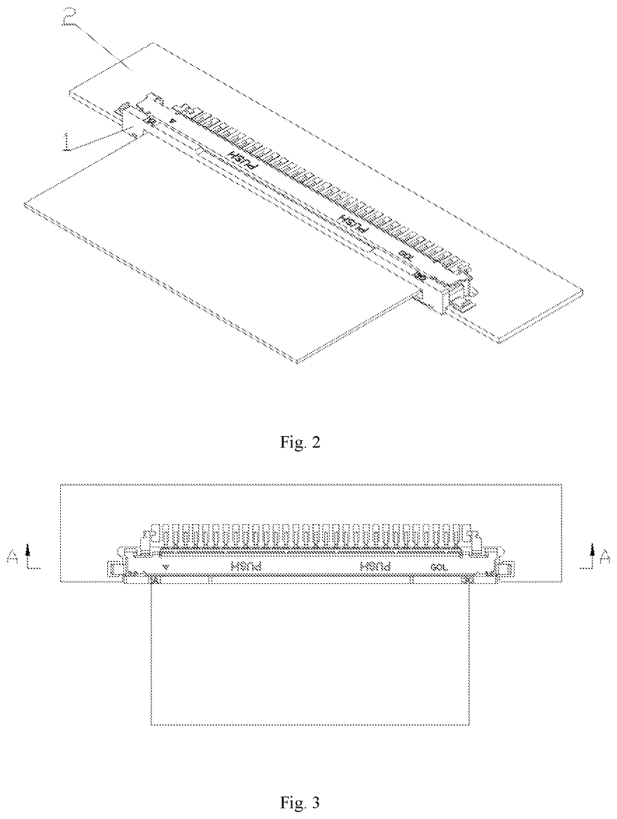

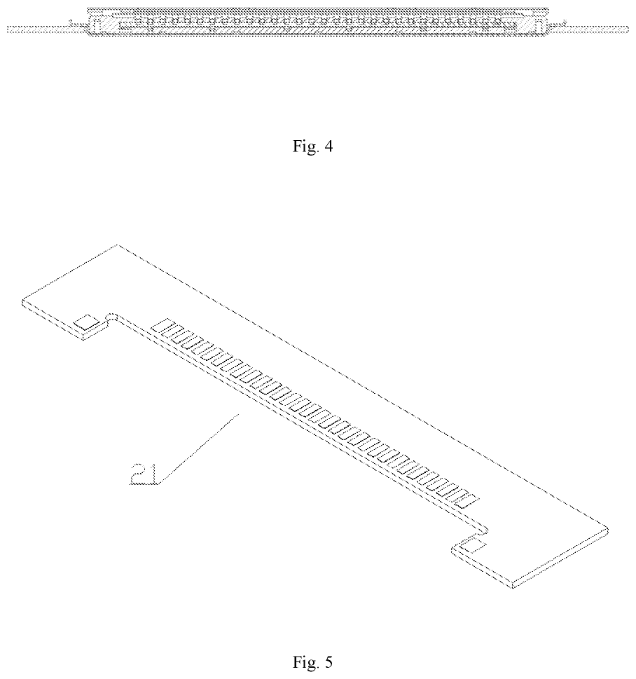

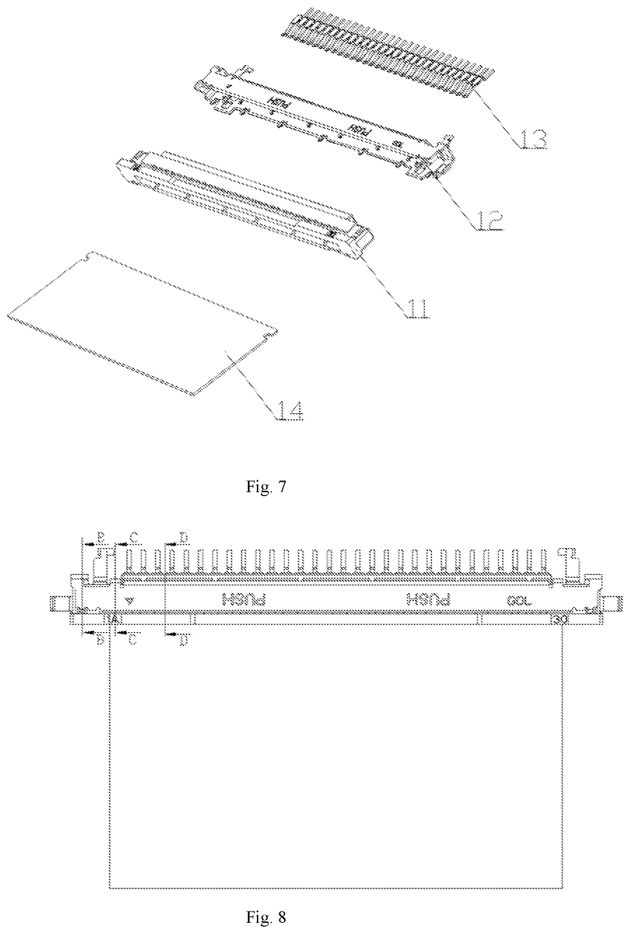

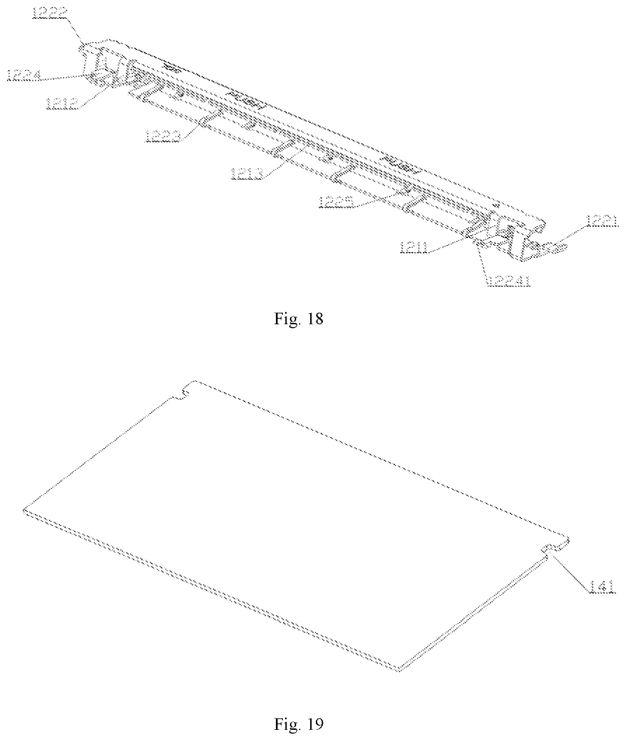

The content of the present invention will be further described below in detail in combination with specific embodiments. FIG. 2, FIG. 3 and FIG. 4 respectively show a three-dimensional schematic diagram, a top view and an A-A section view of the installation structure of the sunken FPC connector in the present invention. It can be seen that the installation structure of the sunken FPC connector is composed of an FPC connector 1 and a circuit board 2, which are fixedly connected to each other, wherein an installation port 21 extends rearward from the front side wall of the circuit board 2 (as shown in FIG. 5). The FPC connector 1 comprises an insulating plastic base 11, a shell 12, wiring terminals 13 and an FFC (as shown in FIG. 7). The shell 12 comprises a top plate 121, a bottom plate 122, and a connecting plate 123 connected between the rear ends of the top plate 121 and the bottom plate 122 (as shown in FIG. 14 and FIG. 18). A first bending fixed arm 1221 and a second bending fixed arm 1222 respectively extend upward from the left and right ends of the bottom plate 122 (as shown in FIG. 14 and FIG. 18). After being put in place relative to the installation port 21, the shell 12 is welded and fixed with the circuit board 2 by means of the first bending fixed arm 1221 and the second bending fixed arm 1222, respectively. In this way, on one hand, the overall height value of the installation structure of the FPC connector is effectively reduced, which is conducive to the miniaturization and integrated design of its superior components; and on the other hand, an enough space is reserved for the implementation of installation and disassembly operations of the FFC 14.

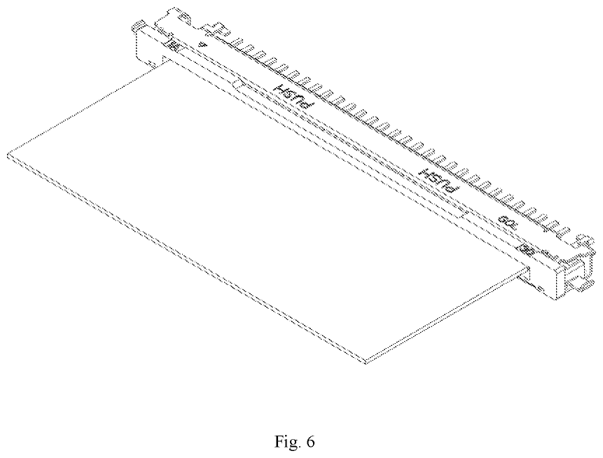

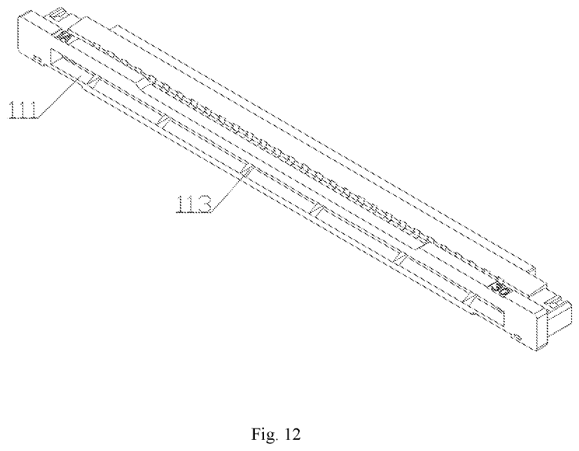

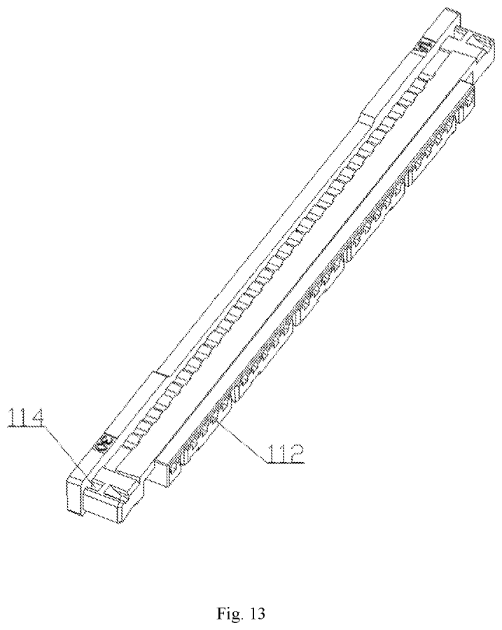

It should be noted here that FIG. 6 and FIG. 7 respectively show a three-dimensional schematic diagram and an exploded view of the FPC connector in the installation structure of the sunken FPC connector in the present invention. It can be seen that an insertion slot 111 is formed in the insulating plastic base 11 for inserting the FFC flat cable 14. A series of insertion holes 112 are evenly distributed along the length direction of the insertion slot 111 for inserting and fixing the wiring terminals 13 (as shown in FIG. 12 and FIG. 13). As can be seen from FIG. 6, the extension direction of the first side 124 of the shell 12 in this embodiment is the same as the insertion direction of the circuit board 2, and the extension direction of the second side 125 of the shell 12 is perpendicular to the insertion direction of the circuit board 2.

In the prior art, in order to realize the grounding function of the FPC connector 1, a relatively common way is to add grounding terminals, which are also inserted and fixed in the insulating plastic base and are arranged side by side with the wiring terminals for conducting signals. However, when the FPC connector with such design structure is assembled, additional procedures are required to complete the positioning and assembly of the grounding terminals, which greatly prolongs the assembly cycle of the FPC connector. In view of this, as a further optimization of the installation structure of the sunken FPC connector, a series of grounding elastic pieces 1223 are evenly distributed along the length direction of the bottom plate 122 for welding and fixing with the FFC 14. In addition, grounding soldering lugs 1224 can also extend outward from the rear wall of the bottom plate at the left and right ends of the bottom plate 122 (as shown in FIG. 14 and FIG. 18). The grounding soldering lugs 1224 are welded and fixed with the circuit board 2 (as shown in FIG. 2). By adopting the above technical solutions for arrangement, on one hand, the FPC connector 1 has an EMI function, which is conducive to signal transmission; and on the other hand, under the premise of meeting the grounding function of the FPC connector 1, the grounding soldering lugs 1224 are used for replacing the traditional grounding terminals, thereby not only greatly simplifying the design structure of the FPC connector 1, but also effectively reducing the assembly difficulty and shortening the assembly time consumption of the FPC connector.

During actual use, when the FPC connector 1 is subjected to an external force, displacement or twist will be inevitably generated relative to the circuit board 2, which easily causes cracks to the grounding soldering lugs 1224 on the FPC connector along the root, resulting in affecting the ultimate service life of the FPC connector. In view of this, elastic bending portions 12241 can be additionally arranged on the grounding soldering lugs 1224. The elastic bending portions 12241 are formed by flatly folding the free ends of the grounding soldering lugs 1224 along the left and right direction (as shown in FIG. 18). In this way, the own elasticity of the grounding soldering lugs 1224 is increased to a certain extent, thereby improving the movable displacement and the torsion resistance of the grounding soldering lugs.

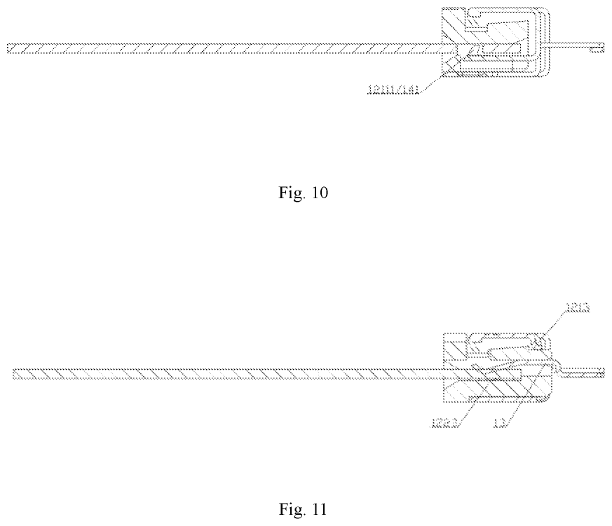

Further, from the consideration of improving the disassembly and assembly efficiency of the FFC 14 as much as possible, a first clamping arm 1211 and a second clamping arm 1212 can also extend downward at positions close to the left and right ends of the top plate 121. And upward extending clamping portions 12111 are arranged at the free ends of the first clamping arm 1211 and the second clamping arm 1212, and are adapted to installation slots 141 formed on the bottom surface of the FFC 14 (as shown in FIG. 10 and FIG. 19). In addition, the clamping portions 12111 are formed by folding the free end of the first clamping arm 1211 or the second clamping arm 1212 in half. Flanges 1213 extend downward from the rear side wall of the top plate 121 (as shown in FIG. 11, FIG. 14 and FIG. 18). When the front end of the top plate 121 is pressed, the top plate rotates around the center axis of the flanges 1213, so that the clamping portions 12111 move downward relative to the installation slots 141 on the bottom surface of the FFC 14, until departing from the slots, so as to complete the unlocking operation of the FFC 14. Compared with the traditional push-pull or clamshell FPC connector, in the technical solution disclosed by the present invention, the rod pushing or cover lifting action is omitted, and the installation and disassembly of the FFC 14 in the shell 12 can be realized just by pressing the shell 12. More importantly, the free ends of the clamping portions 12111 are folded in half, that is, the areas of thrust surface of the FFC 14 is increased when receiving the action of the clamping portions 12111. When the FFC 14 is subjected to a pulling force, it is ensured that the stress value on the side walls of the installation slots 141 on the FFC is reduced to prevent the FFC from being damaged, and thus the connection reliability of the FFC is ensured.

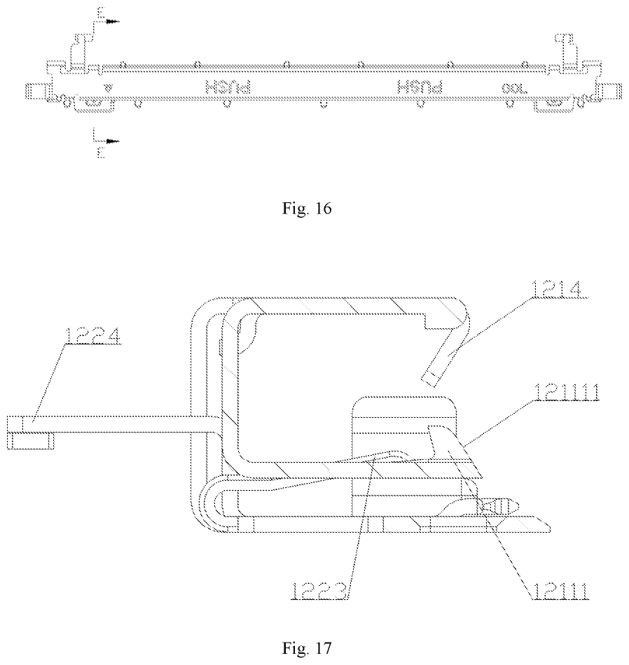

From the consideration of reducing the insertion difficulty of the FFC 14, inclined portions 121111 can also be arranged on the front side walls of the clamping portions 12111. The inclination direction of the inclined portions 121111 is consistent with the insertion direction of the FFC 14 (as shown in FIG. 16 and FIG. 17), so that the clamping stagnation phenomenon of the FFC 14 during the insertion process can be effectively prevented, and the insertion speed is greatly improved.

Furthermore, from the same consideration of improving the connection reliability between the shell 12 and the insulating plastic base 11, multiple fixed jaws 1225 (as shown in FIG. 14) are evenly distributed on the front end portion of the bottom plate 122 and along the length direction thereof. Correspondingly, sliding slots 113 (as shown in FIG. 11) adapted to the fixed jaws 1225 are formed on the bottom of the insulating plastic base 11, and sealing portions (not shown in the figures) are arranged at the tail ends of the sliding slots 113. When the shell 12 is inserted into the insulating plastic base 11, the fixed jaws 1225 always slide along the sliding slots 113 to ensure the smooth insertion of the shell 12. In addition, the fixed jaws 1225 are inserted into the chute sealing portions. In this way, when the FPC connector 1 is subjected to a torsion force, the shell 12 can be effectively prevented from departing from the insulating plastic base 11.

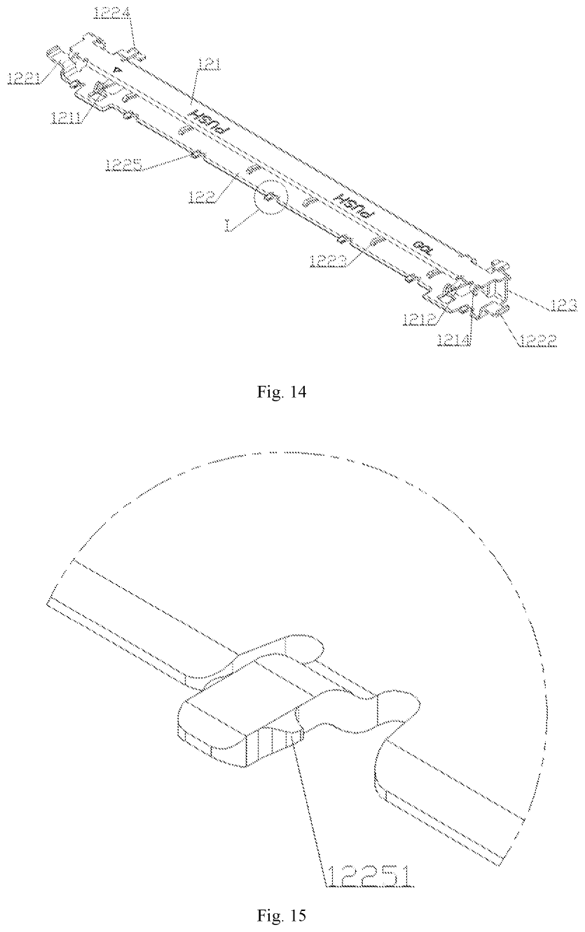

Furthermore, in order to further improve the connection reliability between the shell 12 and the insulating plastic base 11, as an optimization, protrusions 12251 (as shown in FIG. 15) can also be arranged on the both side walls of the fixed claws 1225, so as to improve the sliding fit accuracy of the fixed jaws 1225 and the sliding slots 113.

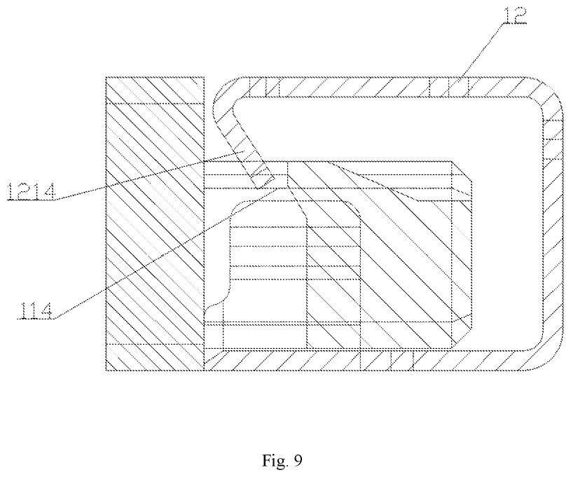

Finally, in order to further improve the reliability of connection and fixation between the shell 12 and the insulating plastic base 11, as an optimization, hook portions 1214 can also extend downward along the left and right ends of the top plate 121. Correspondingly, hook grooves 114 (as shown in FIG. 8, FIG. 9, FIG. 13, FIG. 14 and FIG. 17) adapted to the hook portions 1214 extend downward from the top wall of the insulating plastic base 11, thereby effectively preventing the shell 12 from departing from the insulating plastic base 11 in use.

Through the foregoing description of the disclosed embodiments, those skilled in the art can implement or use the present invention. Various modifications to these embodiments will be obvious to those skilled in the art, and the general principles defined herein can be implemented in other embodiments without departing from the spirit or scope of the present invention. Therefore, the present invention will not be limited to these embodiments shown herein, but should conform to the widest scope consistent with the principles and novel features disclosed herein.

1-8. (canceled)

9. A Flexible Printed Circuit (FPC) assembly, comprising:
an FPC connector, comprising:
an insulating plastic base, the insulating plastic base is provided with an insertion slots, and a plurality of insertion holes are provided in the insertion slots;
a shell, comprising a top plate, a bottom plate and a connecting plate, the connecting plate is arranged between a rear end of the top plate and the bottom plate, and the shell having two opposite first sides and two opposite second sides, wherein the bottom plate comprises a first bending fixed arm and a second bending fixed arm, which respectively extend from the two first sides;
wiring terminals, in plug-in connection with the insertion holes; and
a flexible flat cable, in plug-in connection with the insertion slots; and
a circuit board, provided with an installation port adapted to an outer contour of the FPC connector;
wherein, when the circuit board is inserted into the FPC connector, and after the FPC connector is in abutting contact with the installation port, the circuit board is connected with the first bending fixed arm and the second bending fixed arm by welding, respectively, thereby realizing the connection and fixation between the FPC connector and the circuit board.

10. The FPC assembly according to claim 9, wherein the bottom plate further comprises a plurality of grounding elastic pieces arranged along a length direction of the bottom plate, and the grounding elastic pieces are welded and fixed with the flexible flat cable.

11. The FPC assembly according to claim 9, wherein the bottom plate further comprises at least two grounding soldering lugs extending outward from one second side away from the circuit board, and the grounding soldering lugs are connected to the circuit board by welding, wherein an extension direction of the first sides is the same as an insertion direction of the circuit board.

12. The FPC assembly according to claim 11, wherein the grounding soldering lugs further comprise elastic bending portions, which are formed by bending tail ends of the grounding soldering lugs along a length direction of the bottom plate.

13. The FPC assembly according to claim 10, wherein the top plate further comprises a first clamping arm and a second clamping arm, which extend from one second side close to the circuit board toward the bottom plate, at least two clamping portions extend from a tail end of the first clamping arm and/or the second clamping arm toward the top plate, and the two clamping portions are adapted to at least two installation slots formed on the flexible flat cable.

14. The FPC assembly according to claim 13, wherein the top plate further comprises a plurality of flanges extending from one second side away from the circuit board and toward the bottom plate; when one second side of the top plate is pressed, the top plate rotates around a central axis of the flanges, such that the clamping portions move toward a direction away from the installation slots on the both sides of the flexible flat cable, thereby realizing a separation between the flexible flat cable and the insertion slots.

15. The FPC assembly according to claim 14, wherein inclined portions are arranged at one ends of the clamping portions close to the circuit board, and an inclination direction of the inclined portions is consistent with the insertion direction of the flexible flat cable.

16. The FPC assembly according to claim 13, wherein the bottom plate further comprises a plurality of fixed jaws extending outward from one second side close to the circuit board, and sliding slots adapted to the fixed jaws are formed on the insulating plastic base.

17. The FPC assembly according to claim 16, wherein the fixed jaws comprise protrusions extending from two corresponding sides of the fixed jaws.

18. The FPC assembly according to claim 13, wherein the top plate further comprises hook portions extending from one second side close to the circuit board and toward the bottom plate, and recesses adapted to the hook portions are formed in the insulating plastic base.
